(19) United States
(12) Patent Application Publication
(10) Pub. No.: US 2026/0113120 A1
(43) Pub. Date: Apr. 23, 2026

(54) AUTOMATIC GAIN CONTROL (AGC) LOOP CONVERGENCE USING MACHINE LEARNING (ML) PREDICTION MODEL

(71) Applicant: QUALCOMM Incorporated, San Diego, CA (US)

(72) Inventors: Raveesh JUNEJA, Hyderabad (IN); Hriday GOYAL, Bhopal (IN); Krishna Teja YELLAPRAGADA, Hyderabad (IN)

(21) Appl. No.: 18/922,140

(22) Filed: Oct. 21, 2024

(51) Int. Cl. H04B 10/294; H04L 41/16

(52) U.S. Cl. CPC H04B 10/2942; H04L 41/16

(57) ABSTRACT

A method for wireless communication by a user equipment (UE) includes predicting a future gain state and a gain state transition in the UE based on a number of previous power levels of a received signal. The method also includes modifying a dynamic quantized gain state table, based on the predicting, to cover a likely dynamic range of the received signal. The method further includes switching gain states in accordance with the modified dynamic quantized gain state table.

### FIELD OF THE DISCLOSURE

The present disclosure relates generally to wireless communications, and more specifically to improving automatic gain control (AGC) loop convergence using a machine learning (ML) prediction model.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

Artificial neural networks (or machine learning models) may comprise interconnected groups of artificial neurons (e.g., neuron models). The artificial neural network may be a computational device or represented as a method to be performed by a computational device. Convolutional neural networks, such as deep convolutional neural networks, are a type of feed-forward artificial neural network. Convolutional neural networks may include layers of neurons that may be configured in a tiled receptive field. It would be desirable to apply neural network processing to wireless communications to achieve greater efficiencies.

### SUMMARY

In aspects of the present disclosure, a method for wireless communication by a user equipment (UE) includes predicting a future gain state and a gain state transition in the UE based on a number of previous power levels of a received signal. The method also includes modifying a dynamic quantized gain state table, based on the predicting, to cover a likely dynamic range of the received signal. The method further includes switching gain states in accordance with the modified dynamic quantized gain state table.

Other aspects of the present disclosure are directed to an apparatus. The apparatus has one or more memories and one or more processors coupled to the memory. The processor(s) is configured to predict a future gain state and a gain state transition in the UE based on a number of previous power levels of a received signal. The processor(s) is also configured to modify a dynamic quantized gain state table, based on the predicting, to cover a likely dynamic range of the received signal. The processor(s) is further configured to switch gain states in accordance with the modified dynamic quantized gain state table.

In other aspects of the present disclosure, a non-transitory computer-readable medium with program code recorded thereon is disclosed. The program code is executed by a processor and includes program code to predict a future gain state and a gain state transition in the UE based on a number of previous power levels of a received signal. The program code also includes program code to modify a dynamic quantized gain state table, based on the predicting, to cover a likely dynamic range of the received signal. The program code further includes program code to switch gain states in accordance with the modified dynamic quantized gain state table.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 illustrates an example implementation of designing a neural network using a system-on-a-chip (SOC), including a general-purpose processor, in accordance with various aspects of the present disclosure.

FIGS. 5A, 5B, and 5C are diagrams illustrating a neural network, in accordance with various aspects of the present disclosure.

FIG. 5D is a diagram illustrating an exemplary deep convolutional network (DCN), in accordance with various aspects of the present disclosure.

FIG. 6 is a block diagram illustrating an exemplary deep convolutional network (DCN), in accordance with various aspects of the present disclosure.

FIG. 7 and FIG. 8 are graphs illustrating gain state (GS) transitions.

FIG. 9 is a block diagram illustrating generating of dynamic quantized gain state tables, in accordance with various aspects of the present disclosure.

FIGS. 10A and 10B illustrate graphs showing increasing signal strength and corresponding gain state transitions, respectively.

FIG. 11 is a flow diagram illustrating a processor-implemented machine learning method for automatic gain control (AGC) loop convergence, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based wireless communications systems employing automatic gain control (AGC).

Automatic gain control (AGC) is a technique that adjusts a gain of a receiver in accordance with a power of a received signal, such as a receive signal strength indicator (RSSI). A low noise amplifier (LNA) of the receiver, for example, may modulate the LNA gain to achieve a high gain signal with low noise. AGC techniques may be implemented in an AGC loop.

An AGC loop takes multiple frames to converge when a signal varies. Until the AGC loop converges, user equipment (UE) performance is sub-optimal due to signal-to-noise ratio (SNR) degradation. The problem is evident in frequency division duplexed (FDD) or time division duplexed (TDD) systems, as well as in fading scenarios or other real world scenarios. Strong jamming signals exacerbate the problem, causing the AGC loop to take significant amount of time to converge as the loop traverses through all the gain states (GS), from a lowest gain to a highest gain and vice-versa, depending on the power of the input signal.

According to aspects of the present disclosure, faster AGC loop convergence results from using a machine learning (ML) prediction model. The ML model helps to predict gain states and gain state transitions, during the steady state, based on the power levels (e.g., RSSI). The ML model learns from the power levels, and accordingly, modifies a dynamic quantized gain state table. The dynamic quantized gain state table enables faster gain state switching.

According to aspects of the present disclosure, the ML model learns fluctuations in power level. The learned fluctuations may be used to dynamically refresh the dynamic quantized gain state table based on signal variation. That is, a subset of gain states may be focused on for transitioning. The ML model also learns UE metrics, such as timing advance (TA), RSSI, mobility, etc. The UE metrics can be used to predict whether a signal power level will increase or decrease, therefore limiting gain states to traverse.

In accordance with predicting whether a signal power level will increase or decrease, the dynamic quantized gain state table is populated to cover the dynamic range for the most likely signal power range. The predicting may be based on the past ‘n’ measurements, e.g., the past five measurements. The updated dynamic quantized gain state table improves the UE performance when high signal fluctuations are seen, for example, when receiving jamming signals (e.g., up to 25 dB) and experiencing poor signal conditions.

Techniques for implementing the machine learning approach are also discussed. The techniques include an initial seed approach and a learn on the go approach.

Particular aspects of the subject matter described in this disclosure can be implemented to realize one or more of the following potential advantages. In some examples, the described techniques, such as gain state switching in accordance with machine learning predictions may non-linearly switch gain states, improving automatic gain control (AGC) loop convergence in response to signal variation. As a result, UE performance improves with less signal-to-noise ratio (SNR) degradation. Any scenario involving high signal fluctuations that occurs indoors or outdoors benefits from the techniques of the present disclosure. The present disclosure has application in carrier aggregation cases, where up to eight downlink (DL) carriers are supported in 5G new radio (NR) networks. Similarly, the techniques of the present disclosure are advantageous in networks deployed in high frequency ranges, such as frequency range two (FR2).

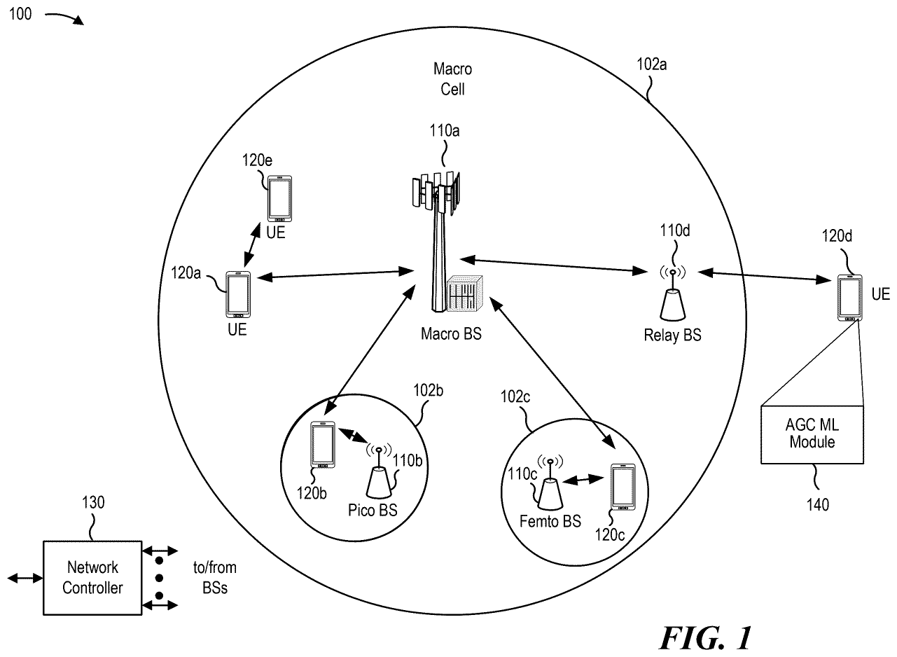

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B, an access point, a transmit and receive point (TRP), a network node, a network entity, and/or the like. A BS can be implemented as an aggregated base station, as a disaggregated base station, an integrated access and backhaul (IAB) node, a relay node, a sidelink node, etc. The BS can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. The network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

The UEs 120 may include an automatic gain control (AGC) machine learning (ML) module 140. For brevity, only one UE 120d is shown as including the AGC ML module 140. The AGC ML module 140 may predict a future gain state and a gain state transition in the UE based on a number of previous power levels of a received signal. The AGC ML module 140 may modify a dynamic quantized gain state table, based on the predicting, to cover a likely dynamic range of the received signal. The AGC ML module 140 may switch gain states in accordance with the modified dynamic quantized gain state table.

As indicated above, FIG. 1 is provided merely as an example. Other examples may differ from what is described with regard to FIG. 1.

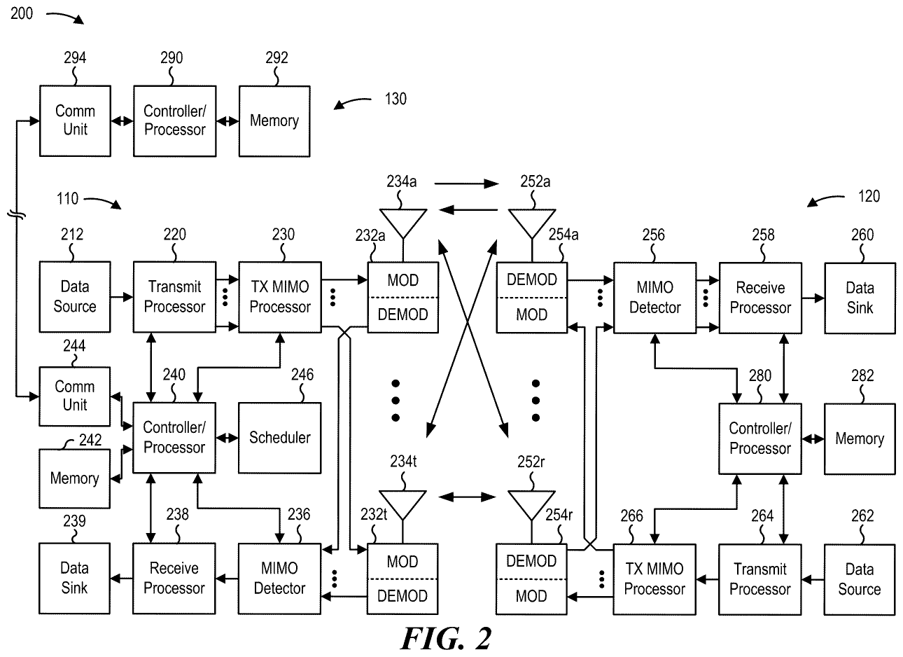

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the network controller 130 via the communications unit 244. The network controller 130 may include a communications unit 294, a controller/processor 290, and a memory 292.

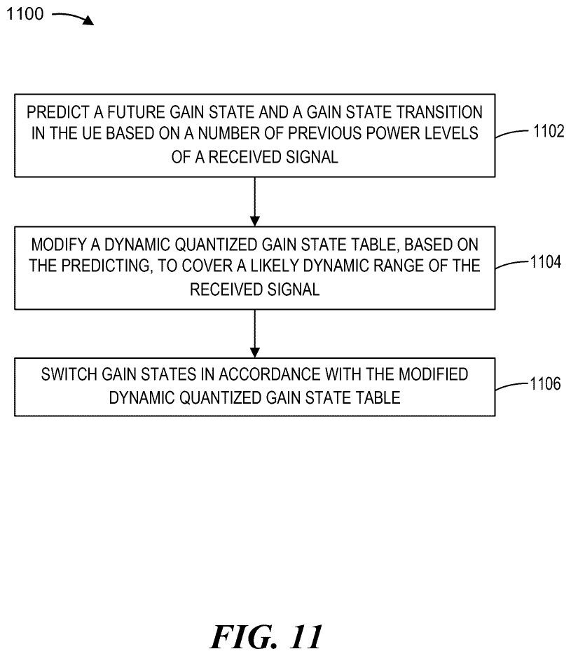

The controller/processor 280 of the UE 120, and/or any other component(s) of FIG. 2 may perform one or more techniques associated with machine learning for automatic gain control, as described in more detail elsewhere. For example, the controller/processor 280 of the UE 120, and/or any other component(s) of FIG. 2 may perform or direct operations of, for example, the processes of FIG. 11 and/or other processes as described. Memory 282 may store data and program codes for the UE 120. A scheduler 246 may schedule UEs for data transmission on the downlink and/or uplink.

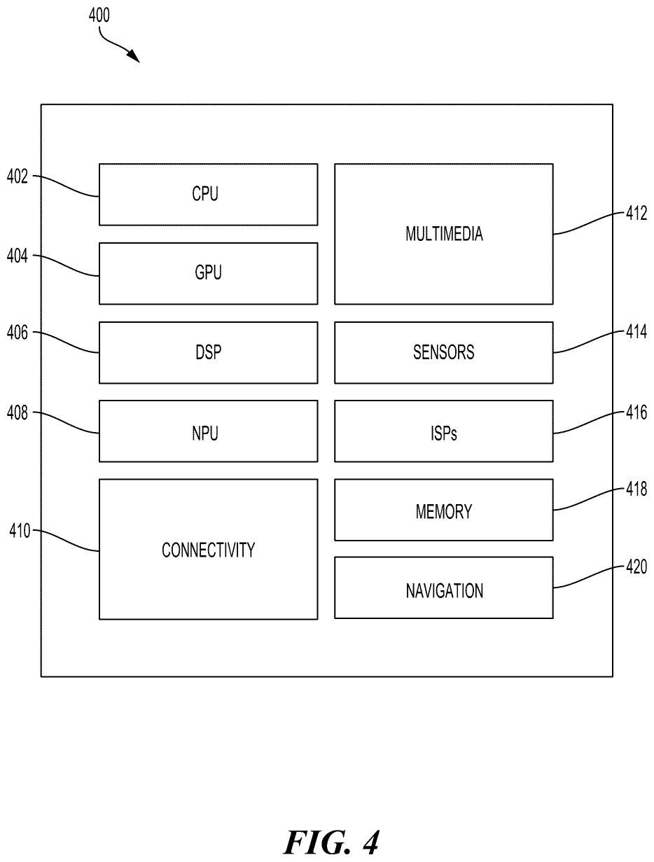

In some aspects, the UE 120 may include means for predicting, means for modifying, means for switching, and means for resetting. Such means may include one or more components of the UE 120 described in connection with FIGS. 2 and 4.

As indicated above, FIG. 2 is provided merely as an example. Other examples may differ from what is described with regard to FIG. 2.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

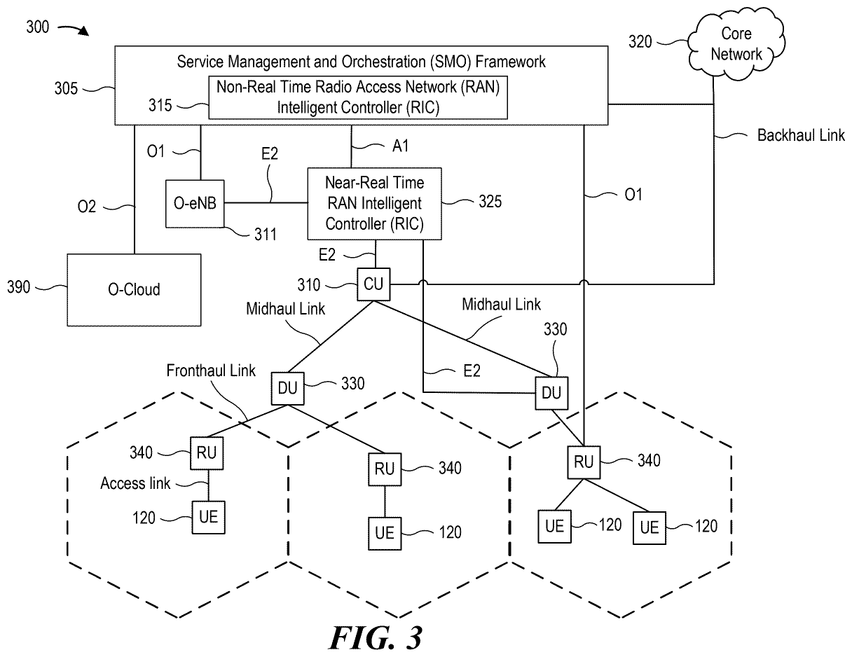

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the Non-RT RIC 315 or the near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

FIG. 4 illustrates an example implementation of a system-on-a-chip (SOC) 400, which may include a central processing unit (CPU) 402 or a multi-core CPU configured for automatic gain control predictions, in accordance with certain aspects of the present disclosure. The SOC 400 may be included in the base station 110 or UE 120. Variables (e.g., neural signals and synaptic weights), system parameters associated with a computational device (e.g., neural network with weights), delays, frequency bin information, and task information may be stored in a memory block associated with a neural processing unit (NPU) 408, in a memory block associated with a CPU 402, in a memory block associated with a graphics processing unit (GPU) 404, in a memory block associated with a digital signal processor (DSP) 406, in a memory block 418, or may be distributed across multiple blocks. Instructions executed at the CPU 402 may be loaded from a program memory associated with the CPU 402 or may be loaded from a memory block 418.

The SOC 400 may also include additional processing blocks tailored to specific functions, such as a GPU 404, a DSP 406, a connectivity block 410, which may include fifth generation (5G) connectivity, fourth generation long term evolution (4G LTE) connectivity, Wi-Fi connectivity, USB connectivity, Bluetooth connectivity, and the like, and a multimedia processor 412 that may, for example, detect and recognize gestures. In one implementation, the NPU is implemented in the CPU, DSP, and/or GPU. The SOC 400 may also include a sensor processor 414, image signal processors (ISPs) 416, and/or navigation module 420, which may include a global positioning system.

The SOC 400 may be based on an ARM, RISC-V (RISC-five), or any reduced instruction set computing (RISC) architecture. In aspects of the present disclosure, the instructions loaded into the general-purpose processor 402 may comprise code to predict a future gain state and a gain state transition in the UE based on a number of previous power levels of a received signal.

In aspects of the present disclosure, the instructions loaded into the general-purpose processor 402 may also comprise code to modify a dynamic quantized gain state table, based on the predicting, to cover a likely dynamic range of the received signal.

In aspects of the present disclosure, the instructions loaded into the general-purpose processor 402 may further comprise code to switch gain states in accordance with the modified dynamic quantized gain state table.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

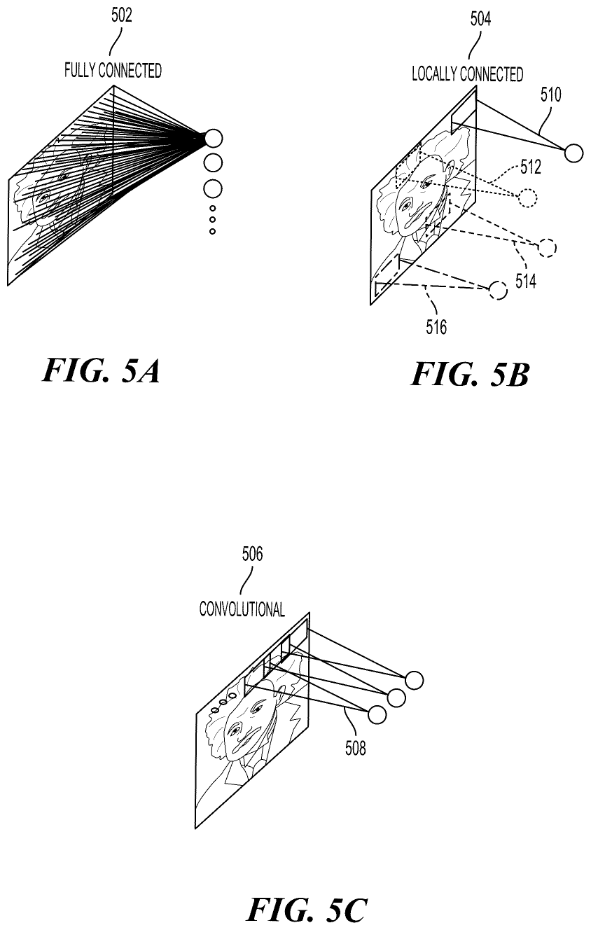

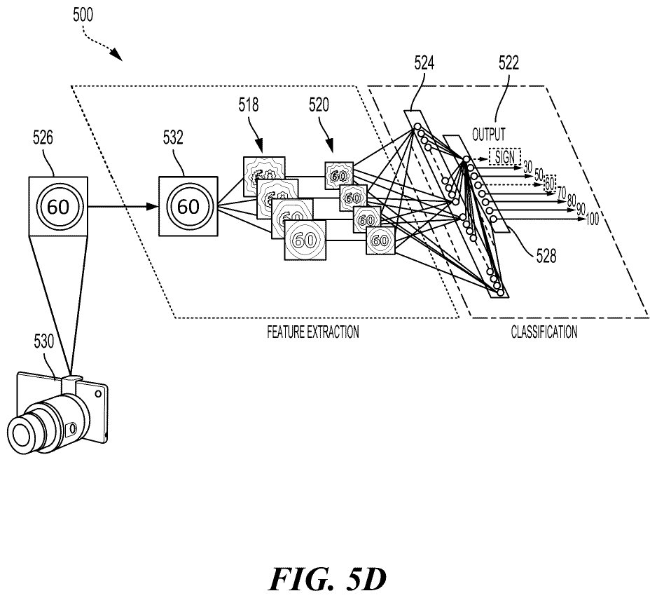

The connections between layers of a neural network may be fully connected or locally connected. FIG. 5A illustrates an example of a fully connected neural network 502. In a fully connected neural network 502, a neuron in a first layer may communicate its output to every neuron in a second layer, so that each neuron in the second layer will receive input from every neuron in the first layer. FIG. 5B illustrates an example of a locally connected neural network 504. In a locally connected neural network 504, a neuron in a first layer may be connected to a limited number of neurons in the second layer. More generally, a locally connected layer of the locally connected neural network 504 may be configured so that each neuron in a layer will have the same or a similar connectivity pattern, but with connections strengths that may have different values (e.g., 510, 512, 514, and 516). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 5C illustrates an example of a convolutional neural network 506. The convolutional neural network 506 may be configured such that the connection strengths associated with the inputs for each neuron in the second layer are shared (e.g., 508). Convolutional neural networks may be well suited to problems in which the spatial location of inputs is meaningful.

One type of convolutional neural network is a deep convolutional network (DCN). FIG. 5D illustrates a detailed example of a DCN 500 designed to recognize visual features from an image 526 input from an image capturing device 530, such as a car-mounted camera. The DCN 500 of the current example may be trained to identify traffic signs and a number provided on the traffic sign. Of course, the DCN 500 may be trained for other tasks, such as identifying lane markings or identifying traffic lights.

The DCN 500 may be trained with supervised learning. During training, the DCN 500 may be presented with an image, such as the image 526 of a speed limit sign, and a forward pass may then be computed to produce an output 522. The DCN 500 may include a feature extraction section and a classification section. Upon receiving the image 526, a convolutional layer 532 may apply convolutional kernels (not shown) to the image 526 to generate a first set of feature maps 518. As an example, the convolutional kernel for the convolutional layer 532 may be a 5×5 kernel that generates 28×28 feature maps. In the present example, because four different feature maps are generated in the first set of feature maps 518, four different convolutional kernels were applied to the image 526 at the convolutional layer 532. The convolutional kernels may also be referred to as filters or convolutional filters.

The first set of feature maps 518 may be subsampled by a max pooling layer (not shown) to generate a second set of feature maps 520. The max pooling layer reduces the size of the first set of feature maps 518. That is, a size of the second set of feature maps 520, such as 14×14, is less than the size of the first set of feature maps 518, such as 28×28. The reduced size provides similar information to a subsequent layer while reducing memory consumption. The second set of feature maps 520 may be further convolved via one or more subsequent convolutional layers (not shown) to generate one or more subsequent sets of feature maps (not shown).

In the example of FIG. 5D, the second set of feature maps 520 is convolved to generate a first feature vector 524. Furthermore, the first feature vector 524 is further convolved to generate a second feature vector 528. Each feature of the second feature vector 528 may include a number that corresponds to a possible feature of the image 526, such as “sign,” “60,” and “100.” A softmax function (not shown) may convert the numbers in the second feature vector 528 to a probability. As such, an output 522 of the DCN 500 may be a probability of the image 526 including one or more features.

In the present example, the probabilities in the output 522 for “sign” and “60” are higher than the probabilities of the others of the output 522, such as “30,” “40,” “50,” “70,” “80,” “90,” and “100”. Before training, the output 522 produced by the DCN 500 likely be incorrect. Thus, an error may be calculated between the output 522 and a target output. The target output is the ground truth of the image 526 (e.g., “sign” and “60”). The weights of the DCN 500 may then be adjusted so the output 522 of the DCN 500 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 500 may be presented with new images (e.g., the speed limit sign of the image 526) and a forward pass through the DCN 500 may yield an output 522 that may be considered an inference or a prediction of the DCN 500.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 520) receiving input from a range of neurons in the previous layer (e.g., feature maps 518) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

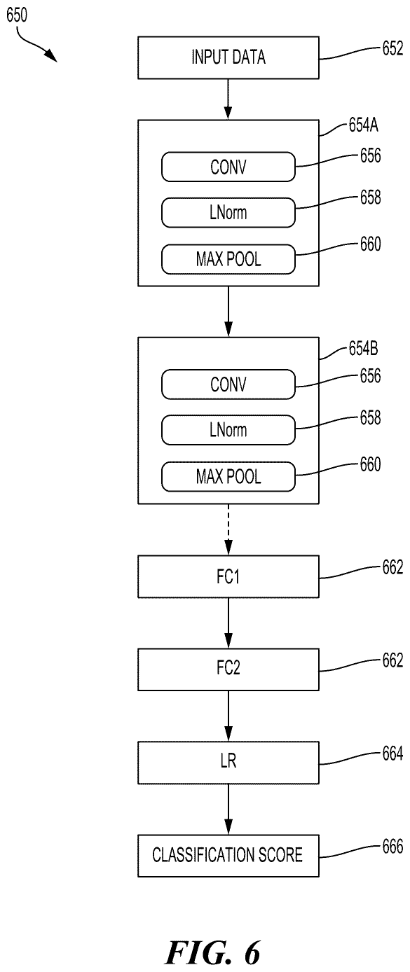

FIG. 6 is a block diagram illustrating a deep convolutional network 650. The deep convolutional network 650 may include multiple different types of layers based on connectivity and weight sharing. As shown in FIG. 6, the deep convolutional network 650 includes the convolution blocks 654A, 654B. Each of the convolution blocks 654A, 654B may be configured with a convolution layer (CONV) 656, a normalization layer (LNorm) 658, and a max pooling layer (MAX POOL) 660. Although only two of the convolution blocks 654A, 654B are shown, the present disclosure is not so limiting, and instead, any number of the convolution blocks 654A, 654B may be included in the deep convolutional network 650 according to design preference.

The convolution layers 656 may include one or more convolutional filters, which may be applied to the input data to generate a feature map. The normalization layer 658 may normalize the output of the convolution filters. For example, the normalization layer 658 may provide whitening or lateral inhibition. The max pooling layer 660 may provide down sampling aggregation over space for local invariance and dimensionality reduction.

The parallel filter banks, for example, of a deep convolutional network may be loaded on a CPU 402 or GPU 404 of an SOC 400 (e.g., FIG. 4) to achieve high performance and low power consumption. In alternative embodiments, the parallel filter banks may be loaded on the DSP 406 or an ISP 416 of an SOC 400. In addition, the deep convolutional network 650 may access other processing blocks that may be present on the SOC 400, such as sensor processor 414 and navigation module 420, dedicated, respectively, to sensors and navigation.

The deep convolutional network 650 may also include one or more fully connected layers 662 (FC1 and FC2). The deep convolutional network 650 may further include a logistic regression (LR) layer 664. Between each layer 656, 658, 660, 662, 664 of the deep convolutional network 650 are weights (not shown) that are to be updated. The output of each of the layers (e.g., 656, 658, 660, 662, 664) may serve as an input of a succeeding one of the layers (e.g., 656, 658, 660, 662, 664) in the deep convolutional network 650 to learn hierarchical feature representations from input data 652 (e.g., images, audio, video, sensor data and/or other input data) supplied at the first of the convolution blocks 654A. The output of the deep convolutional network 650 is a classification score 666 for the input data 652. The classification score 666 may be a set of probabilities, where each probability is the probability of the input data, including a feature from a set of features.

As indicated above, FIGS. 4-6 are provided as examples. Other examples may differ from what is described with respect to FIGS. 4-6.

Automatic gain control (AGC) is a technique that adjusts a gain of a receiver in accordance with a power of a received signal, such as a receive signal strength indicator (RSSI). A low noise amplifier (LNA) of the receiver, for example, may modulate the LNA gain to achieve a high gain signal with low noise. AGC techniques may be implemented in an AGC loop.

An AGC loop takes multiple frames to converge when a signal varies. Until the AGC loop converges, user equipment (UE) performance is sub-optimal due to signal-to-noise ratio (SNR) degradation. The problem is evident in frequency division duplexed (FDD) or time division duplexed (TDD) systems, as well as in fading scenarios or other real world scenarios. Strong jamming signals exacerbate the problem, causing the AGC loop to take significant amount of time to converge as the loop traverses through all the gain states (GS), from a lowest gain to a highest gain and vice-versa, depending on the power of the input signal. Any scenario involving high signal fluctuations that occurs indoors or outdoors would benefit from the techniques of the present disclosure. The present disclosure also has application in carrier aggregation cases, where up to eight downlink (DL) carriers are supported in 5G new radio (NR) networks. Similarly, the techniques of the present disclosure are advantageous in networks deployed in high frequency ranges, such as frequency range two (FR2).

AGC calculations are part of receive signal strength indicator (RSSI) calculations. AGC does not react to instantaneous RSSI values. Rather, AGC processes monitor the RSSI for multiple slots or sub-frames before starting gain state transitions.

Gain states are traversed one step at a time, rather than instantaneously, when switching between gain states. The step-by-step transition leads to longer convergence times. For example, if the gain state switches from gain state six (GS6) to gain state zero (GS0) based on power levels of the received signal, then the gain state transitions may be represented as:
(GS6 to GS5 to GS4 to GS3 to GS2 to GS1 to GS0).

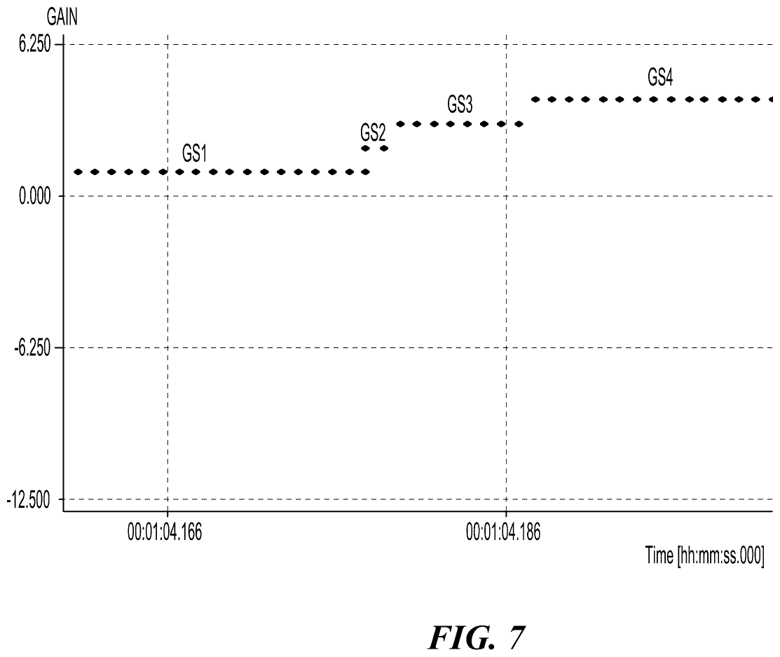

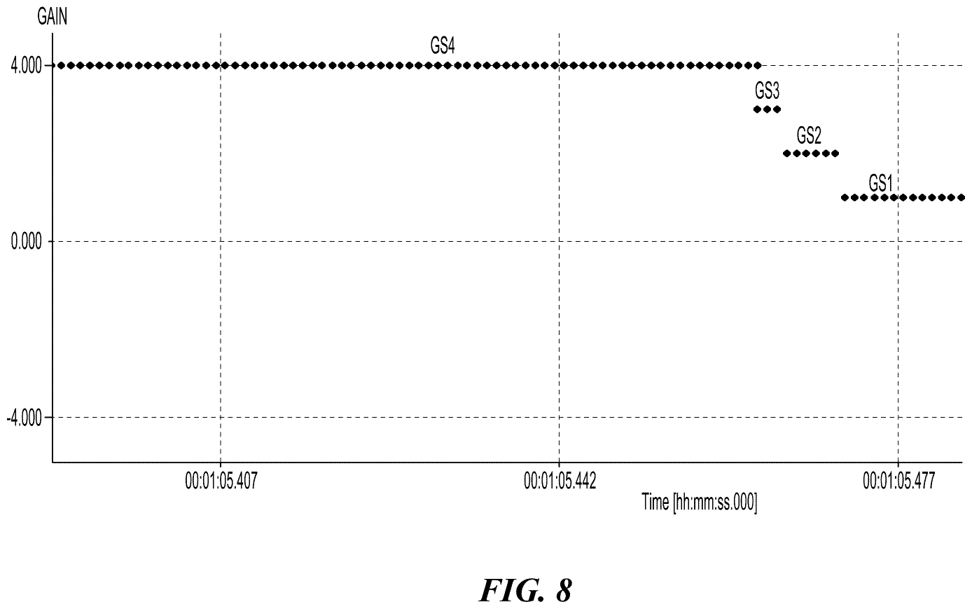

FIG. 7 and FIG. 8 are graphs illustrating gain state (GS) transitions. FIG. 7 shows gain state transitions from GS1 to GS4, when the RSSI increases. In the example of FIG. 7, the gain state transitions from GS1 to GS2 to GS3 and finally to GS4. FIG. 8 shows gain state transitions from GS4 to GS1, when the RSSI decreases. In the example of FIG. 8, the gain state transitions from GS4 to GS3 to GS2 to GS1.

According to aspects of the present disclosure, faster AGC loop convergence results from using a machine learning (ML) prediction model. The ML model helps to predict gain states and gain state transitions, during the steady state, based on the power levels (e.g., RSSI). The ML model learns from the power levels, and accordingly, modifies a dynamic quantized gain state table. The dynamic quantized gain state table enables faster gain state switching.

According to aspects of the present disclosure, the ML model learns fluctuations in power level. The learned fluctuations help in dynamically refreshing the dynamic quantized gain state table based on signal variation. That is, a subset of gain states may be focused on for transitioning. The ML model also learns UE metrics, such as timing advance (TA), RSSI, mobility, etc. The UE metrics can be used to predict whether a signal power level will increase or decrease, therefore limiting gain states to traverse.

In accordance with the predicting, the dynamic quantized gain state table is populated to cover the dynamic range for the most likely signal power range. The predicting may be based on the past ‘n’ measurements, e.g., the past five measurements.

The updated dynamic quantized gain state table improves the UE performance when high signal fluctuations are seen, for example, when receiving jamming signals (e.g., up to 25 dB) and experiencing poor signal conditions.

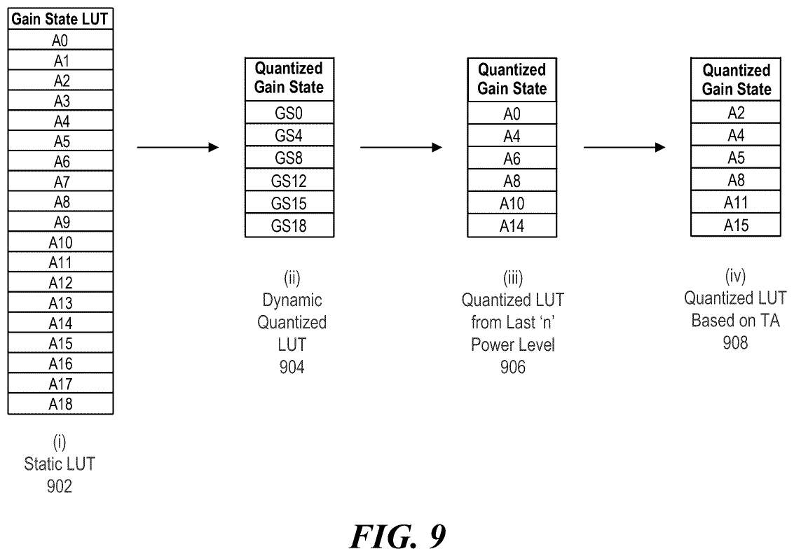

FIG. 9 is a block diagram illustrating generating of dynamic quantized gain state tables, in accordance with various aspects of the present disclosure. To generate dynamic quantized gain state tables, the UE initially creates a first dynamic quantized gain state lookup table (LUT) 904 from a static gain state lookup table 902, based on critical low noise amplifier (LNA) gain switch points. The static gain state lookup table 902 is an initial table that is stored in the UE, and may also be referred to as a legacy gain state lookup table. The first dynamic gain state lookup table 904 is refreshed based on predictions using one or more metrics, such as last ‘n’ power levels where n can vary, depending on the UE operational mode. A second dynamic quantized gain state lookup table 906 is generated based on the last ‘n’ power levels and timing advance (TA) values. Other table updates may be based on additional metrics, such as mobility, etc. In the example of FIG. 9, a third dynamic quantized gain state lookup table 908 is generated based on timing advance metrics. Both tables 906 and 908 are taken together and not one after another. In other words, both tables 906 and 908 are generated using the combination of power level and TA, such that the final decision is based on a combination of power level and TA. The UE looks at power level to transition the gain state, but the dynamic quantized LUT prediction is based on TA.

In the cases where the UE travels closer to the base station, the power level is expected to increase along with the gain state. Hence, the quantized table will have lower gain states replaced with higher gain states, as shown in the third dynamic quantized gain state lookup table 908. That is, GS-A0 and GS-A1 from the second dynamic quantized gain state lookup table 906 do not appear in the third dynamic quantized gain state lookup table 908. Similarly, GS-A5 is skipped in the second table 906 but reappears in the third table 908.

An example will now be described assuming the current power level is −a dBm. If the dynamic range to be covered for the dynamic quantized gain state lookup table is z dBm, then (−x, −y) dBm is the range considered to evaluate the switch points for the gain state transition.

In another example, the current power levels are at extreme values: −a dBm or −b dBm. In this example, the complete dynamic range shifts in one of the directions and quantized gain states are predicted in a more optimized manner. For example, if the current power level is −a dBm, then the quantized table will have lower gain states replaced with higher gain states.

Timing advance metrics facilitate predicting of future power levels. When moving towards the base station, the timing advance changes. Consequently, the power level changes. ML prediction based on power level can be based on timing advance metrics. For example, if the timing advance is decreasing, then the UE is likely moving towards the base station. Thus, the likelihood is that the signal will increase, which indicates that the gain states will increase. Accordingly, the dynamic range for quantization moves in the higher direction, resulting in a quantized table populated with higher gain states. That is, the full dynamic range need not be covered by the table: the lower gain states are not covered by the table in this example.

If moving away from the base station, the timing advance increases. The power level will also change. Based on these observations, the machine learning prediction will change, resulting in a gain state table with improved accuracy.

If it is observed that for last ‘n’ measurements that predictions indicate the signal and gain state should increase, but the gain state starts decreasing, then the gain states are transitioning against the prediction. According to aspects of the present disclosure, in this scenario the quantized table resets to the original static lookup table and legacy procedures are followed.

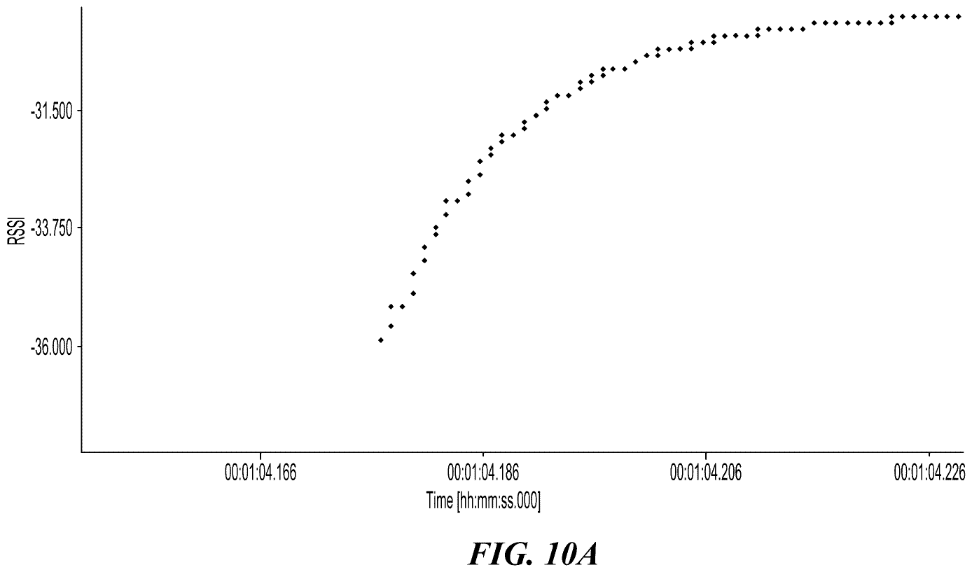

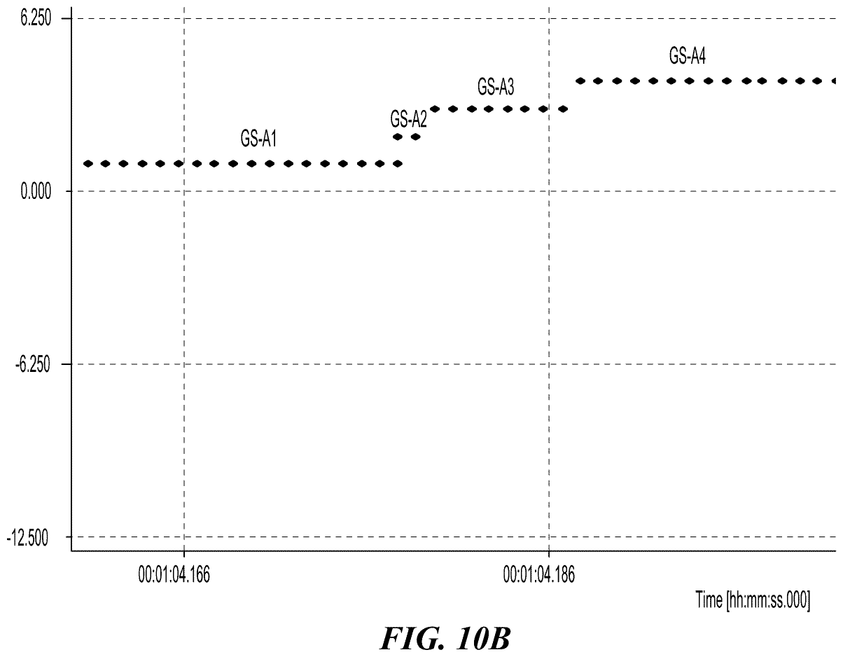

FIGS. 10A and 10B illustrate graphs showing increasing signal strength and corresponding gain state transitions, respectively. In FIG. 10A, a total receive signal strength indicator (RSSI) increases due to the presence of a jammer. In FIG. 10B, the gain state (GS) transitions from gain state one (GS-A1) to gain state four (GS-A4) as a result of the increased RSSI. As seen in FIG. 10B, three steps are involved in the transition from GS-A1 to GS-A4. Aspects of the present disclosure reduce the number of transition steps for indoor and outdoor scenarios with high signal fluctuations by implementing machine learning models with existing hardware and without increasing power consumption. For example, the gain state may change in a non-linear manner (e.g., directly from GS-A2 to GS-A4). Such aspects are particularly useful in carrier aggregation scenarios, such as those supporting eight downlink carriers, and also high frequency range scenarios (e.g., frequency range two (FR2)).

Solutions for implementing the ML approach are now discussed. In a first solution, an initial seed is used. The initial seed is predetermined data, such as a factory trained calibration data set. As additional data sets are collected from earlier factory runs, these data sets may train the machine learning model in the factory. The machine learning model helps converge the automatic gain control (AGC) loop faster once the UE enters a connected state. That is, the factory training elicits some coarse gain states, for example, GS-A1 and GS-A5. Selected gain states, for example, GS-A2, GS-A3, and GS-A4, may be selected later, for example, when the UE is connected to the network, e.g., after using the initial factory seeds.

Another solution includes a machine learning model that learns ‘on the go.’ That is, the model learns from initial AGC loop transitions and continuously uses the same data to train the machine learning model. The model shows a gradual improvement in AGC convergence. In case of a prediction failure, the quantized gain state table is reset and the UE falls back to a legacy lookup table. In summary, the two methods differ with respect to the initial seed. The first method uses the initial seed as described above with some seeds coming from the factory. The second method starts with the static gain state lookup table 902 seen in FIG. 9.

In these solutions, the ML prediction model does not react to instantaneous RSSI fluctuations. The model is monitored for a period of time (e.g., window) and triggered if a value α_IIR is greater than a threshold or less than the threshold plus a hysteresis. Once triggered, a dynamic lookup table is used to calculate a next gain state. The value of α_IIR represents the difference between an instantaneous RSSI and a filtered RSSI, for example, filtered with an infinite impulse response (IIR) filter. A parameter γ represents the outer loop gain for machine learning based IIR. The range of values that γ_IIR assumes is higher than the traditional AGC outer loop gain. For example, if the outer loop gain γ is 0.05 and a higher jump in RSSI is observed, then the filtered RSSI loop will be faster compared to normal loop gain by a factor m. The factor m depends on network conditions, such as mobility, stationary condition (where timing advance (TA) is constant), etc. More specifically, the equation IIR=α_current* γ+(1−γ)*α_IIR represents the IIR with an outer loop gain variable that determines the contribution from the reading as γ% of contribution coming from the last reading while the rest comes from the IIR output corresponding to the previous reading.

An example will now be described assuming α_IIR=α_current. During the steady state, if c=instantaneous RSSI in the current slot and d=instantaneous RSSI in the previous slot, then α_current=c−d. Accordingly, the current α_IIR will be calculated as: α_IIR=α_current*β+(1−β)*α_IIR.

As an example, γ ε (0.05, 0.25). Next, the α_IIR value is compared to a maximum threshold, in a sliding window of n slots. If the α_IIR value is greater than the threshold or lower than the threshold plus a hysteresis, then the ML-based gain state computation occurs. In the ML computation, a new gain state is found from the quantized lookup table based on an ML_TOTAL_RSSI value. The value ML_TOTAL_RSSI varies in accordance with the value of α_IIR. The β value is output from the ML model. With different values of β, the rate of gain state convergence changes. Based on the UE metrics and number of gain states in the quantized gain state lookup table, the parameter γ changes appropriately. In this way, over n measurements, a final gain state is calculated from the quantized lookup table, where n is lower than the number of measurements taken with legacy AGC methods. Stated another way, ML_TOTAL_RSSI=RSSI_inst_current*β+(1−β)*ML_TOTAL_RSSI. The ML_TOTAL_RSSI represents the filtered RSSI value.

A numerical example will now be discussed. Assume α_IIR=5 dB, the threshold=5.4 dB, c=−60 dBm, and d=−53 dBm. The α_current value=|c−d|=7 dB. The α_IIR value=α_current*β+(1−β)*α_IIR=7*0.25+0.75*5=5.5 dB. Because α_IIR (5.5 dB)>threshold (5.4 dB) during a window, the ML gain state computation starts. Similarly, if the α_IIR value is greater than the threshold during the window, and also lower than the threshold plus hysteresis, then ML gain state computation takes place. In some implementations, the value is greater than the threshold+hysteresis and less than the threshold−hysteresis. In other implementations, the value is greater than the threshold and less than the threshold−hysteresis.

Another example will now be described. Initially, TOTAL_RSSI=b from the legacy AGC loop, the current RSSI=a, and the initial seed for filtered RSSI=α=b, where α=the current ML-filtered-RSSI α=β×a+(1−β)×b and β=loop gain for ML based IIR. If |α−b|>Threshold over the window, then ML gain state computation starts. Similarly, if |α−b| is greater than the threshold over the window, and is lower than the threshold+hysteresis, then ML gain state computation takes place. In some implementations, the value is greater than the threshold+hysteresis and less than the threshold−hysteresis. In other implementations, the value is greater than the threshold and less than the threshold−hysteresis.

In the ML GS computation, a new gain state is found from the quantized lookup table based on ML_TOTAL_RSSI. The value ML_TOTAL_RSSI varies in accordance with the value of α. The β value is output from the ML model. With different values of β, the rate of gain state convergence changes. Based on the UE metrics and number of gain states in the quantized gain state lookup table, the parameter β changes accordingly. In this way, over n measurements, the final gain state is calculated from the quantized lookup table, where n will be lower than the number of measurements taken with legacy AGC methods.

FIG. 11 is a flow diagram illustrating a processor-implemented machine learning (ML) method 1100 for automatic gain control (AGC) loop convergence, in accordance with various aspects of the present disclosure. The processor-implemented ML method 1100 may be performed by one or more processors such as the CPU (e.g., 402), GPU (e.g., 404), and/or other processing unit (e.g., DSP 406), for example.

At block 1102, the user equipment (UE) predicts a future gain state and a gain state transition in the UE based on a number of previous power levels of a received signal. For example, the UE (e.g., using the controller/processor 280, memory 282, and or the like) may predict the future gain state. The predicting may be based on a current timing advance metric and/or a UE mobility level, and may occur with an artificial neural network.

At block 1104, the user equipment (UE) modifies a dynamic quantized gain state table, based on the predicting, to cover a likely dynamic range of the received signal. For example, the UE (e.g., using the controller/processor 280, memory 282, and or the like) may modify the dynamic quantized gain state table. The UE may reset the dynamic quantized gain state table to an original static gain state table in response to observed conditions indicating the predicting is inaccurate.

At block 1106, the user equipment (UE) switches gain states in accordance with the modified dynamic quantized gain state table. For example, the UE (e.g., using the controller/processor 280, memory 282, and or the like) may switch gain states. In some aspects, the gain states switch non-linearly.

### Example Aspects

Implementation examples are described in the following numbered clauses.

Aspect 1: A method of wireless communication by a user equipment (UE), comprising: predicting a future gain state and a gain state transition in the UE based on a plurality of previous power levels of a received signal; modifying a dynamic quantized gain state table, based on the predicting, to cover a likely dynamic range of the received signal; and switching gain states in accordance with the modified dynamic quantized gain state table.

Aspect 2: The method of Aspect 1, further comprising predicting based on at least one of a current timing advance metric or a UE mobility level.

Aspect 3: The method of Aspect 1 or 2, further comprising resetting the dynamic quantized gain state table to an original static gain state table in response to observed conditions indicating the predicting is inaccurate.

Aspect 4: The method of any of the preceding Aspects, in which the predicting occurs with an artificial neural network, and the method further comprises training the artificial neural network based on an initial seed.

Aspect 5: The method of any of the Aspects 1-3, in which the predicting occurs with an artificial neural network, and the method further comprises training the artificial neural network with data collected during initial automatic gain control transitions.

Aspect 6: The method of any of the preceding Aspects, in which the predicting occurs in response to a change in power level during a time duration exceeds a threshold.

Aspect 7: The method of any of the preceding Aspects, in which switching gain states occurs non-linearly.

Aspect 8: An apparatus for wireless communication by a user equipment (UE), comprising: at least one memory; and at least one processor coupled to the at least one memory, the at least one processor configured: to predict a future gain state and a gain state transition in the UE based on a plurality of previous power levels of a received signal; to modify a dynamic quantized gain state table, based on the predicting, to cover a likely dynamic range of the received signal; and to switch gain states in accordance with the modified dynamic quantized gain state table.

Aspect 9: The apparatus of Aspect 8, in which the at least one processor is further configured to predict based on at least one of a current timing advance metric or a UE mobility level.

Aspect 10: The apparatus of Aspect 8 or 9, in which the at least one processor is further configured to reset the dynamic quantized gain state table to an original static gain state table in response to observed conditions indicating the predicting is inaccurate.

Aspect 11: The apparatus of any of the Aspects 8-10, in which the at least one processor is further configured to predict with an artificial neural network, and to train the artificial neural network based on an initial seed.

Aspect 12: The apparatus of any of the Aspects 8-10, in which the at least one processor is further configured to predict with an artificial neural network, and to train the artificial neural network with data collected during initial automatic gain control transitions.

Aspect 13: The apparatus of any of the Aspects 8-12, in which the at least one processor is further configured to predict in response to a change in power level during a time duration exceeds a threshold.

Aspect 14: The apparatus of any of the Aspects 8-13, in which gain states switch non-linearly.

Aspect 15: A non-transitory computer-readable medium having program code recorded thereon, the program code executed by a processor and comprising: program code to predict a future gain state and a gain state transition in a user equipment (UE) based on a plurality of previous power levels of a received signal; program code to modify a dynamic quantized gain state table, based on the predicting, to cover a likely dynamic range of the received signal; and program code to switch gain states in accordance with the modified dynamic quantized gain state table.

Aspect 16: The non-transitory computer-readable medium of Aspect 15, in which the program code comprises program code to predict based on at least one of a current timing advance metric or a UE mobility level.

Aspect 17: The non-transitory computer-readable medium of Aspect 15 or 16, in which the program code comprises program code to reset the dynamic quantized gain state table to an original static gain state table in response to observed conditions indicating the predicting is inaccurate.

Aspect 18: The non-transitory computer-readable medium of any of the Aspects 15-17, in which the program code to predict operates as an artificial neural network, and the program code further comprises program code to train the artificial neural network based on an initial seed.

Aspect 19: The non-transitory computer-readable medium of any of the Aspects 15-17, in which the program code predict operates as an artificial neural network, and the program code further comprises program code to train the artificial neural network with data collected during initial automatic gain control transitions.

Aspect 20: The non-transitory computer-readable medium of any of the Aspects 15-19, in which the program code to predict responds to a change in power level during a time duration exceeds a threshold.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE), comprising:
predicting a future gain state and a gain state transition in the UE based on a plurality of previous power levels of a received signal;
modifying a dynamic quantized gain state table, based on the predicting, to cover a likely dynamic range of the received signal; and
switching gain states in accordance with the modified dynamic quantized gain state table.

2. The method of claim 1, further comprising predicting based on at least one of a current timing advance metric or a UE mobility level.

3. The method of claim 1, further comprising resetting the dynamic quantized gain state table to an original static gain state table in response to observed conditions indicating the predicting is inaccurate.

4. The method of claim 1, in which the predicting occurs with an artificial neural network, and the method further comprises training the artificial neural network based on an initial seed.

5. The method of claim 1, in which the predicting occurs with an artificial neural network, and the method further comprises training the artificial neural network with data collected during initial automatic gain control transitions.

6. The method of claim 1, in which the predicting occurs in response to a change in power level during a time duration exceeds a threshold.

7. The method of claim 1, in which switching gain states occurs non-linearly.

8. An apparatus for wireless communication by a user equipment (UE), comprising:
at least one memory; and
at least one processor coupled to the at least one memory, the at least one processor configured:
to predict a future gain state and a gain state transition in the UE based on a plurality of previous power levels of a received signal;
to modify a dynamic quantized gain state table, based on the predicting, to cover a likely dynamic range of the received signal; and
to switch gain states in accordance with the modified dynamic quantized gain state table.

9. The apparatus of claim 8, in which the at least one processor is further configured to predict based on at least one of a current timing advance metric or a UE mobility level.

10. The apparatus of claim 8, in which the at least one processor is further configured to reset the dynamic quantized gain state table to an original static gain state table in response to observed conditions indicating the predicting is inaccurate.

11. The apparatus of claim 8, in which the at least one processor is further configured to predict with an artificial neural network, and to train the artificial neural network based on an initial seed.

12. The apparatus of claim 8, in which the at least one processor is further configured to predict with an artificial neural network, and to train the artificial neural network with data collected during initial automatic gain control transitions.

13. The apparatus of claim 8, in which the at least one processor is further configured to predict occurs in response to a change in power level during a time duration exceeds a threshold.

14. The apparatus of claim 8, in which gain states switch non-linearly.

15. A non-transitory computer-readable medium having program code recorded thereon, the program code executed by a processor and comprising:
program code to predict a future gain state and a gain state transition in a user equipment (UE) based on a plurality of previous power levels of a received signal;
program code to modify a dynamic quantized gain state table, based on the predicting, to cover a likely dynamic range of the received signal; and
program code to switch gain states in accordance with the modified dynamic quantized gain state table.

16. The non-transitory computer-readable medium of claim 15, in which the program code comprises program code to predict based on at least one of a current timing advance metric or a UE mobility level.

17. The non-transitory computer-readable medium of claim 15, in which the program code comprises program code to reset the dynamic quantized gain state table to an original static gain state table in response to observed conditions indicating the predicting is inaccurate.

18. The non-transitory computer-readable medium of claim 15, in which the program code to predict operates as an artificial neural network, and the program code further comprises program code to train the artificial neural network based on an initial seed.

19. The non-transitory computer-readable medium of claim 15, in which the program code predict is in an artificial neural network, and the program code further comprises program code to train the artificial neural network with data collected during initial automatic gain control transitions.

20. The non-transitory computer-readable medium of claim 15, in which the program code to predict responds to a change in power level during a time duration exceeds a threshold.
